(19) United States
(12) Patent Application Publication
(10) Pub. No.: US 2011/0036005 A1
(43) Pub. Date: Feb. 17, 2011

(54) STRING TRELLIS APPARATUS

(76) Inventors: John E. Aiken, Monroeville, PA (US); Edward Scott Carlson, Delmont, PA (US)

Correspondence Address: James Ray & Associates, 2640 Pitcairn Road, Monroeville, PA, 15146, US

(21) Appl. No.: 12/854,440

(22) Filed: Aug. 11, 2010

Related U.S. Application Data
(60) Provisional application No. 61/232,893, filed on Aug. 11, 2009.

(51) Int. Cl. A01G 9/12

(52) U.S. Cl. 47/70

(57) ABSTRACT

A string trellis apparatus for attachment to elevated substantially horizontal portions of a structure at one end and an elongated planter box at the other, includes at least two elongated hanger members of a first predetermined length each having at least one aperture disposed at a first end and a hook portion disposed at a second end and engageable with at least one of a rain gutter and a fence top; at least two substantially flexible strings having proximal and distal ends; and a planter-box connecting means disposed one of in or on the planter box for removably attaching the proximal ends of the strings to the planter box adjacent a soil surface in the planter box.

### CROSS REFERENCE TO RELATED APPLICATION

This patent application is related to and claims priority from U.S. Provisional Patent Application Ser. No. 61/232,893 filed Aug. 11, 2009.

### FIELD OF THE INVENTION

The present invention relates, in general, to an apparatus for growing plants and, more particularly, this invention relates to a string trellis apparatus for growing plants upwards and/or downward to or from elevated portions of structures such as roof rain gutters.

### BACKGROUND OF THE INVENTION

It has been widely known for many years that numerous plants can be grown downward from elevated soil pots. Tomatoes have been one of the most popular applications, with plants intentionally grown out of the bottom or side of hanging pots. One drawback is the limited amount of natural rainwater that gets to the plant roots, necessitating frequent watering by people.

It is also well known that many plants can be grown up a trellis, including both flowers and vegetables such as morning glories and various varieties of beans. A key advantage of climbing plants is that they grow mostly vertically and thus require minimum ground area. Planter pots and boxes can be placed on porch walls, paved area, or just the ground. An alternative is to hang them from porch roof ceilings, but watering by rainfall is minimal. A major drawback to the open soil top of conventional plant boxes and pots is evaporation of water that necessitates watering by the owners during dry spells. This problem is addressed somewhat by what are commonly called self-watering planters that have a water reservoir at the bottom with an overflow outlet to prevent excessive water accumulation. The bottom reservoir holds water in a manner that will prevent significant evaporation, but the plant roots must be long enough to reach down to near the bottom, a problem for young plants. See for example U.S. Pat. No. 5,638,638 to Moskowitz and products sold by Misco Enterprises.

Kang in U.S. Pat. No. 6,226,921 teaches a self-watering planter using string-like wicking material to bring some of the reservoir water a short distance into the soil. The drawback with the Kang wicking system is that it is flattened considerably by the addition of the soil on top of it, and thus it cannot bring water very high into the soil.

Growing vine-type plants on nets or fence is also well known in the art. Fence-like plant supports attached to pots have been known at least as far back as Dolf in U.S. Pat. No. 597,841. A common problem with the net and fence types is that the net and fence become entangled with the vines, and the cost of the plant support separating the two in the fall or spring.

Unusually long planter boxes have been created by others from long gutter sections hung from a wall then filled with dirt or any growing medium. A similar example can be found in the March 2006 issue of “Martha Stuart Living”, which illustrates a gutter garden made of sections of copper gutter hanging from a porch ceiling, the gutter sections being filled with soil in which plants are grown. As with all the other prior art, these are open top with the upper soil surface completely exposed, which accounts for a high percentage of the water loss due to evaporation. Also, there is little access to natural rainwater. There appears to be nothing in the prior art disclosing a trellis apparatus that can readily attach without tools to existing substantially horizontal structures for growing climbing plants. Watrous in U.S. Pat. No. 377,444 teaches a trellis support with a single structure-mounted section that is attached to vertical portions of a structure. Also, Watrous offers the user only limited variability in the spacing of the strings.

Growing vertically downward from suspended pots is also well known. This may work when weighted down with the fruit, such as with tomatoes, but this technique is less well known for climbing plants. These existing types of downward-growing devices need frequent watering and offer very little capture of rainfall compared even to conventional growing from the ground. Also, they are typically no more than four feet off the ground, not adjustable in height, and offer no protection from deer and the like eating at the plants.

Some prior art patent references generally teach growing plants in troughs or gutters that are not actually in active use for rainwater runoff. See for example U.S. Patent Application Publication No. US 2003/0024159. U.S. Pat. No. 5,966,870 discloses an open-top trough with accordion-like walls. Japanese published application JP2007169922 discloses a gutter device which is not easily understood. As best can be deciphered, the device places wall sections in the gutter to form water and soil holding sections, and in the gutter drain port, an insert creates a slight dam to prevent all of the water from draining out of the gutter. This would create water holding sections, which present the drawback of becoming mosquito-breeding areas. As with most of the other prior art, a rather limited vertical height is accommodated.

### SUMMARY OF THE INVENTION

The present invention provides a string trellis apparatus for attachment to elevated substantially horizontal portions of a structure at one end and an elongated planter box at the other, and the apparatus includes at least two elongated hanger members of a first predetermined length each having at least one aperture disposed at a first end and a hook portion disposed at a second end and engageable with at least one of a rain gutter and a fence top; at least two substantially flexible strings having proximal and distal ends; and a planter-box connecting means disposed one of in or on the planter box for removably attaching the proximal ends of the strings to the planter box adjacent a soil surface in the planter box.

In a preferred embodiment of the invention, the connecting means is a plurality of loops pegs with internal wick material, the pegs extending through the bottom of planter box and above the soil with a loop to tie on the proximal end of the string. Preferably, the elongated hanger members can attach to either a gutter or a fence top.

### OBJECTS OF THE INVENTION

It is, therefore, one of the primary objects of the present invention to provide a novel plant-growing apparatus that enables climbing plants to grow upward and/or downward over a distance between about four and fourteen feet with minimal ground plot from which to grow.

Another object of the present invention is to provide a climbing-plant growing support that can attach to standard window-box planters and existing building rain gutters and readily create tall adjustable-height trellises generally without need for a ladder to install.

Still another object of the present invention is to provide a flower-growing apparatus that can create a curtain of beautiful flowers that also provide shade to a porch or similar area.

Yet another object of the present invention is to provide a plant-growing apparatus which allows plants to be grown without a ground plot and typically where not reachable by wild animals that are known to destroy many ground-based plants.

An additional object of the present invention is to provide a plant-growing apparatus with disposable trellis strings for easy takedown after growing climbing plants upward or downward, or both ways.

Yet still another objective of the present invention is to provide a plant growing apparatus that can capture and retain water such that the plants can go without watering by people for a relatively long period.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 provides a perspective view of the present invention.

FIG. 2 is a perspective view of a hanger portion of the present invention.

FIG. 3 is a side elevation view of a multi-purpose hanger for the present invention.

FIG. 4 is a cross sectional view of an alternative embodiment of the present invention.

FIG. 5 is a perspective view of an optional portion of alternative embodiment.

FIG. 6 provides a perspective view of an alternative embodiment of the present invention is use with a tall privacy fence.

FIG. 7 is a perspective view of an alternative way to hang and space strings from a gutter.

FIG. 8 is a detailed perspective view of an alternative construction of a hanger member.

FIG. 9 provides a perspective view of an alternative way for hanging strings of the present invention from a gutter.

FIG. 10 provides a cross sectional view of the alternative way of hanging strings from a gutter.

FIG. 11 is a partial cross-sectional cutaway elevation view of an alternative embodiment of the present invention.

FIG. 12 provides a plan view of a kit version of the present invention.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

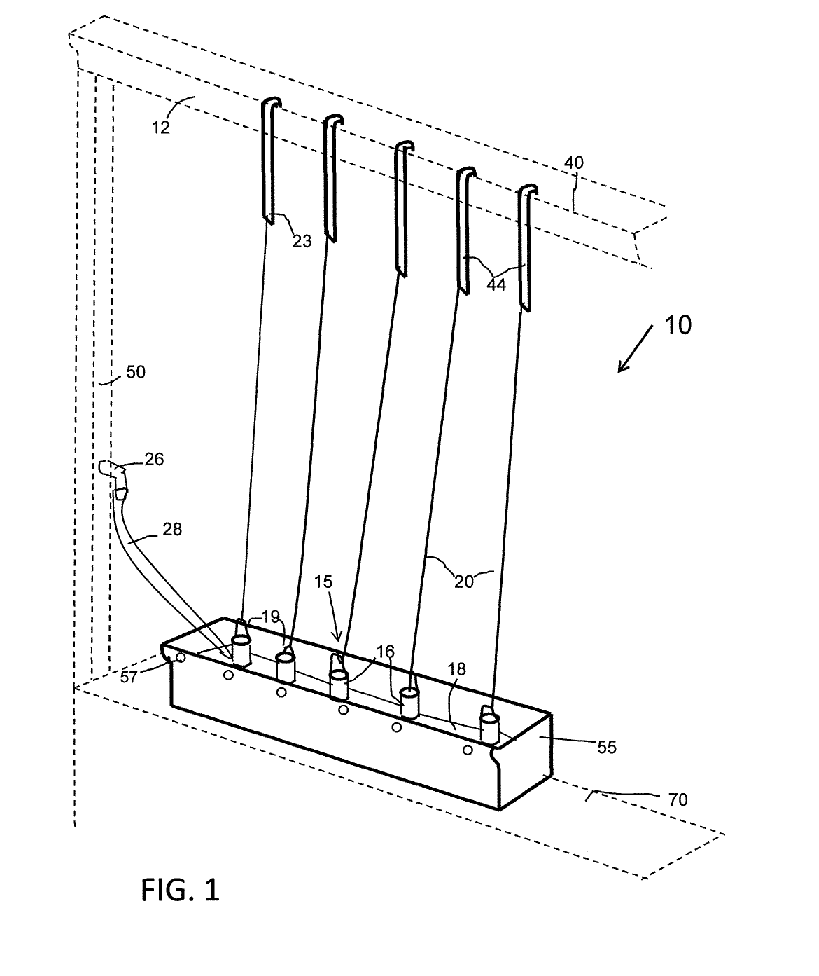

Referring initially to FIG. 1, a perspective view of the present invention, generally shown as 10, is depicted in use in combination with a planter box 55 resting on a surface 70 and partially filled with soil 18. The soil 18 in the planter 55 is to be planted or transplanted with climbing plants such as beans or flowers like morning glories. The string trellis apparatus 10 is typically positioned substantially beneath a typical rain gutter 12 with the planter box 55 commonly more that 4 feet lower than a gutter 12. Elongated individual hanger members 45 are removably connected at an aperture 23 in the first end to the distal end of string 20 and the second end is engageable with the top edge 33 of the gutter 12. The strings 20 are extended substantially vertically downward from the hanger members 45. At the proximal end, the strings 20 are engageable with loops 19 at a top end of loop pegs 15 which have an exposed end 16 above the soil and a flange end removably engaged adjacent the bottom floor of the planter box 55. The planter box 55 is preferably a type with a removable water tray surrounding the bottom. Multiple apertures 57 spaced along the top edge of the planter box provide an alternative means of connecting the strings 20, and when used in combination with elastic bands, the strings 20 are held taut. The replaceable strings 20 can be cut to the appropriate length and are substantially flexible. They may be either synthetic or natural material, such as a sisal or jute twine. Supplemental rain water may optionally be diverted from a downspout 50 with the aid of an insert trough fitting 26 connected at an outlet end to a flexible hose 28 which has an outlet end inserted in the soil 18.

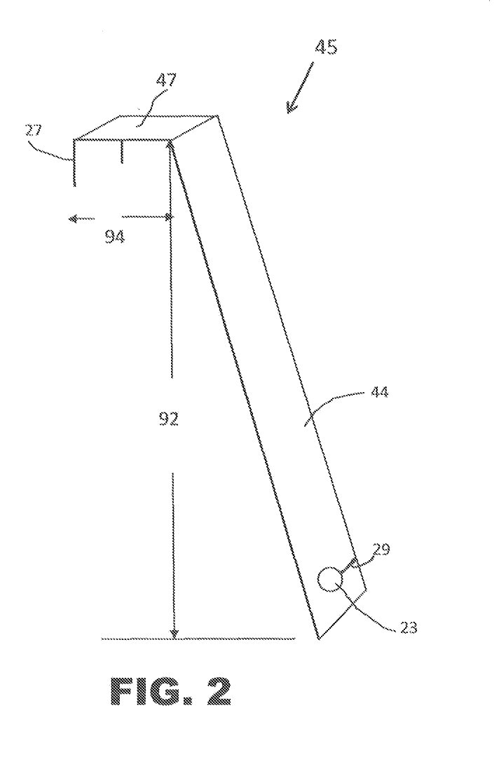

FIG. 2 provides a perspective elevation view of an elongated multi-purpose L-shape hanger member 45 engageable with either a gutter or top edge of a fence. There is an elongated vertical member 44 with a hook portion 47 substantially normal to the vertical member 44 at the end opposite the aperture 23, and has at least one prong 27. An optional slot 29 runs from the aperture 23 to an outer edge. The height 92 will typically be in the range of 9 to 24 inches such that the hanger members can often be hung on elevated horizontal portions of a structure without the need for a ladder. The length 94 of the hook member 47 is preferably between 2 and 3 inches so that it may be removably secured along either the front edge of a gutter or the top of a fence.

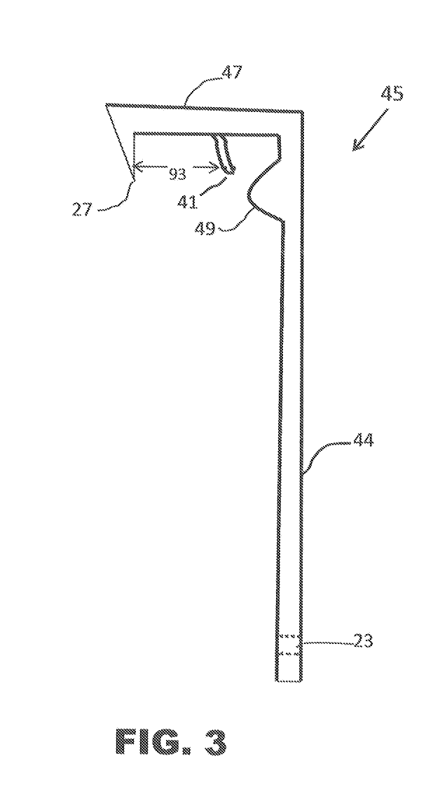

FIG. 3 is a side elevation view of a preferred multi-purpose hanger member 45 with a hook portion 47 having a pronged tip 27 opposite the end attached to the elongated vertical member 44 with the aperture 23 for string attachment. To enhance the snugness of the fit to either a gutter or fence top, the vertical member 44 has an internal hump 49 and there is a tongue protrusion 41 from the underside of the hook portion 47. In order to fit properly on top of common PVC fence panels, the gap 93 between the pronged tip 27 and the tongue protrusion 41 must be between about 1.5 and 3.0 inches.

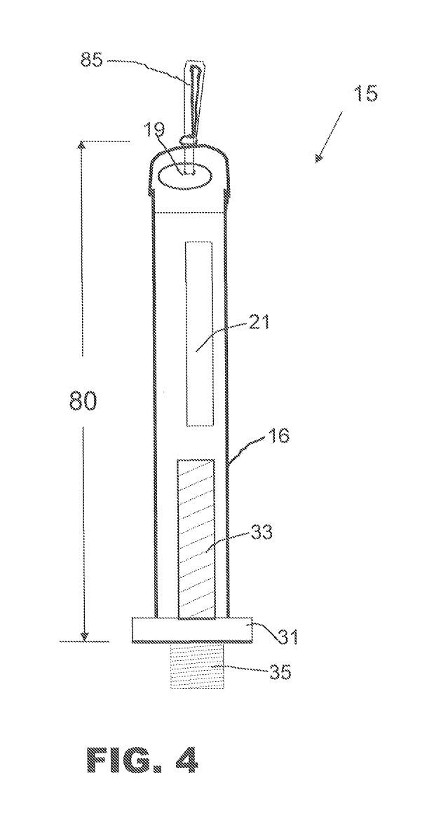

FIG. 4 provides an elevation view of a preferred loop peg 15 for attaching to the proximal ends of the strings in the present invention. A tubular shell 16 is attached to or integral with a bottom flange 31 with a central aperture such that a lower portion 35 of wick material can extend below the flange 31. The tubular shell will typically be pushed up through a slightly larger hole in the bottom of the planter box and the flange 31 restrains it from being pulled all the way through. The lower portion 35 of wick material then rests in the bottom water reservoir of a preferred self-watering planter box. Multiple window slits 21 are created in the wall of the tubular shell 16 to allow access to or escape of water from the internal wick material 33. The overall length 80 of the loop peg is between about 8 and 12 inches such that the top loop 19 will be accessible above the soil level. An optional extension of the loop 19 can be added by threading an elastic band 85 through the loop 19 and then through the other end of the elastic band with the string then tied to the created loop in the elastic band 85. The elastic band helps in keeping the string taut.

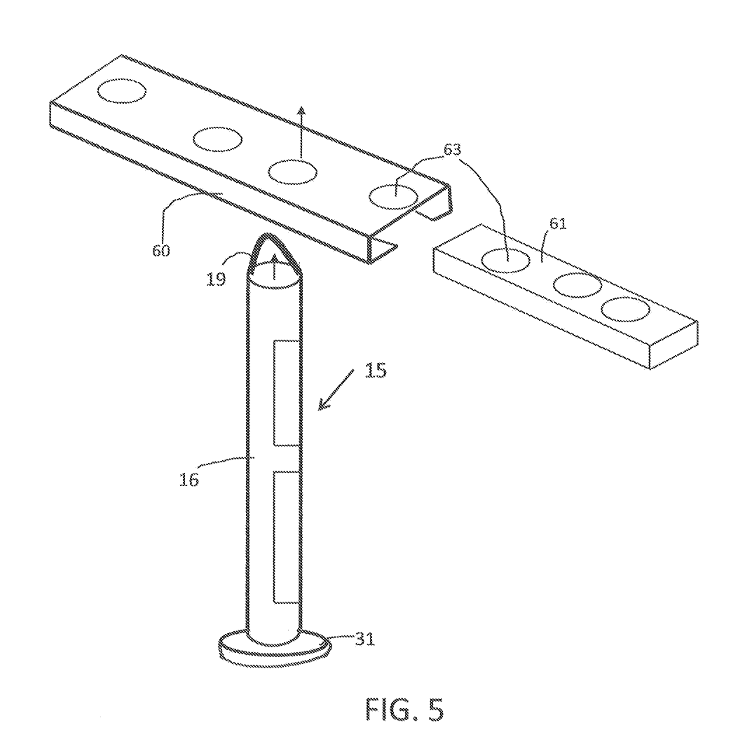

FIG. 5 provides a perspective view of an alternative retention device for the loop pegs 15 inside various sizes of window or deck planter boxes. The retention device consists of two telescoping channels 60 and 61. Each channel has at least three top side apertures 63 large enough for the loop peg 15 to slide through except for the flange portion 31. The two channels nest together with apertures 63 aligned so as to create the appropriate length depending on the length of the planter box. The desired number of loop pegs 15 is pushed up through the apertures 63 until restrained by the flange 31. The combination can then be placed on the inside bottom of a window box and covered with soil.

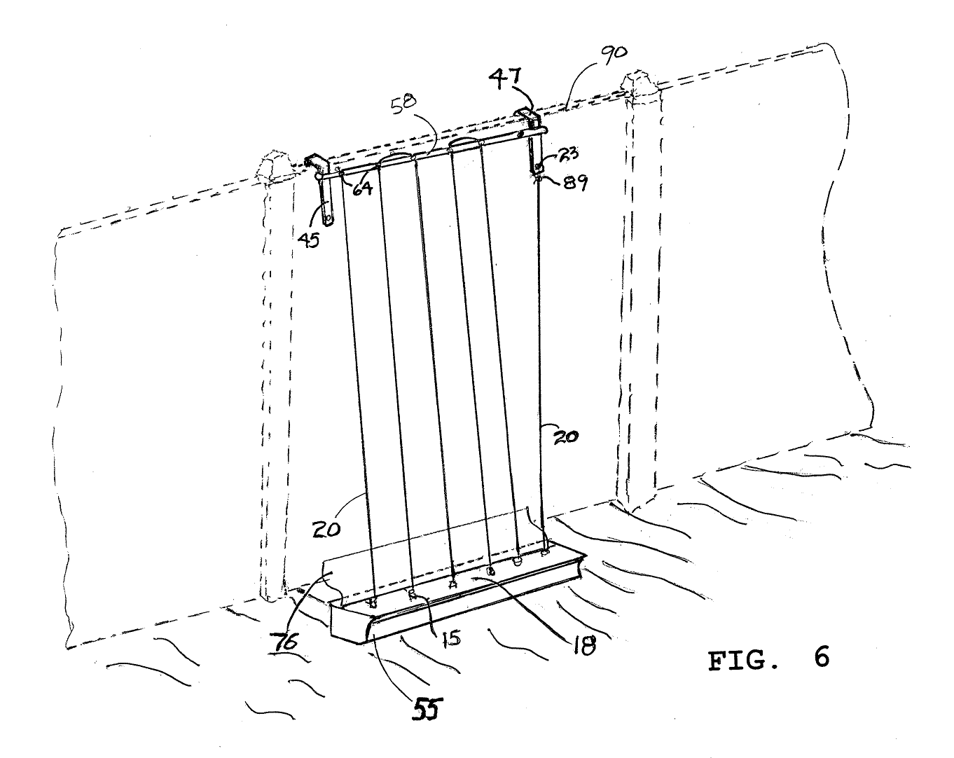

FIG. 6 provides a perspective view of an alternative embodiment of the present invention in use with a tall privacy fence 90. In this case, there are two elongated hanger members 45 attached adjacent each end of an elongated horizontal spacer bar 58 with apertures or eyehooks 64 through or to which the strings 20 can be threaded or tied. This keeps the strings 20 at a fixed spacing. End strings 20 may also be tied to the apertures 23 in the hanger members 45 with any desired knot 89. Climbing plants or flowers are grown in the soil 18 in the planter box 55 and can climb the strings 20 starting near the attachment point of the loop pegs 15. An optional rain collection baffle 76 can augment the capture of water and would work best with a self-watering type of planter box.

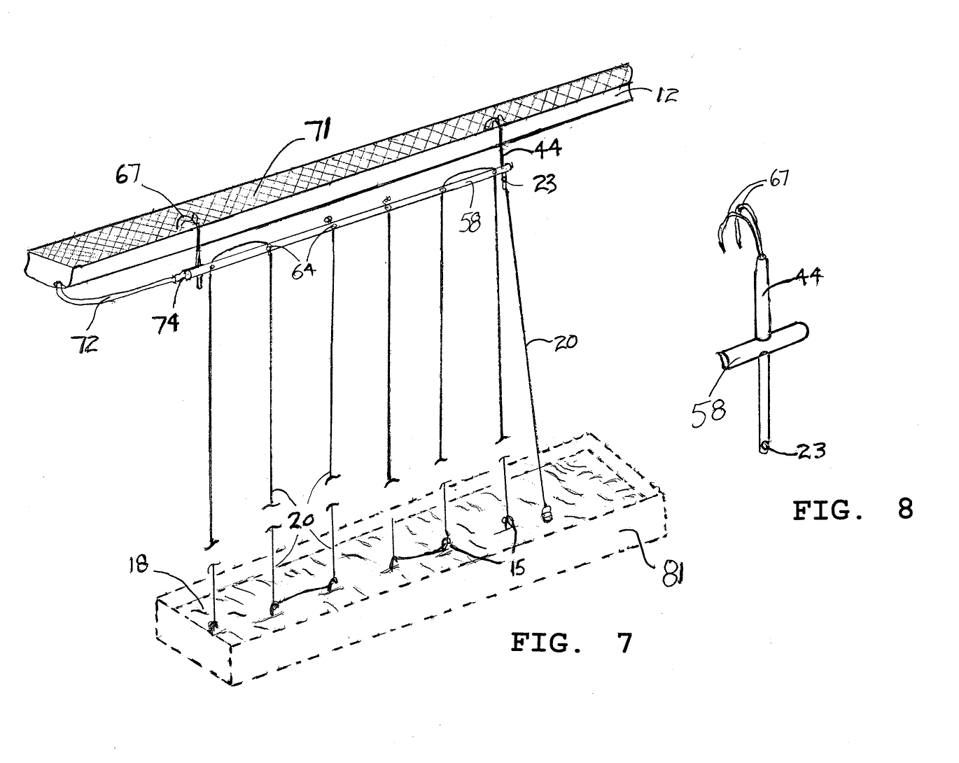

FIG. 7 presents an alternative apparatus for mounting the elongated vertical member 44 to the gutter 12 and for setting the spacing of the cords 20. This apparatus is especially well suited for gutters covered with screens 71 to keep out leaves and debris. Hook arms 67 are attached adjacent the ends of the elongated vertical member 44 and the length of the vertical member helps with raising the apparatus including the spacing bar 58 up from the ground. At the end of the hook arms 67 are arcuate tines that can fit through most gutter screens 70. Even without a screen 71, the hook 67 with the arcuate tines can support the horizontal spacer bar 58 from the top front edge of the gutter 12. The strings 20 are threaded through aperture or eyehooks 64 in the spacer bar 58 to maintain a specific spacing. Preferably, but optionally, a water conduit 72 attaches to a fitting 74 at one end of the spacer bar 58 and to an orifice in the gutter so that rain water may flow into the hollow spacer bar 58 and then down the cords 20. Optionally, the conduit 72 includes a valve in the event no water flow is desired. In this alternative embodiment illustrated, the cords 20 are held adjacent the soil 18 in a raised plant bed 81 with the aid of the partially buried loop pegs 15.

Details of the hook arm and spacer bar 58 are provided in FIG. 8. The vertical member 44 and the horizontal spacer bar 58 can be connected in a number of suitable ways.

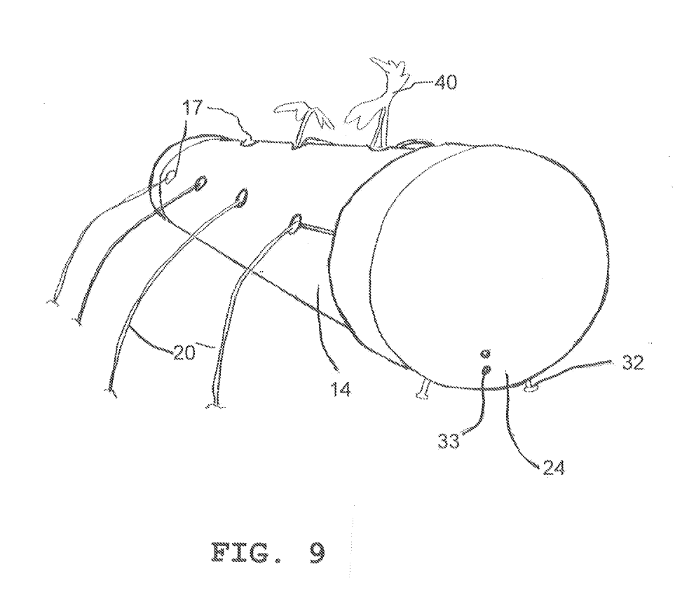

FIG. 9 provides a perspective end view of an alternative embodiment for string attachment at a gutter with the present invention. The elongated shell 14, preferably but optionally cylindrical, has end caps 24 with optional water entry and drain apertures 33. Short legs 32 about one-half inch long preferably, but optionally, are included on the end caps 24 or shell member 14 to aid in positioning the apparatus and to create additional channel space around the apparatus. There are multiple apertures 17 typically at least one-half inch in diameter along a portion of the shell 14. These apertures, which may also be slots, provide a means for securing the cords 20, and allowing plants 40 to grow out as well as being inlet openings for water ingress and drains for excess water. Additional slots or apertures 38 can provide extra locations for water entry as water pours off the roof line, either from rain or a hose. The opposite ends of the cords 20 will attach to the loop pegs as in other embodiments.

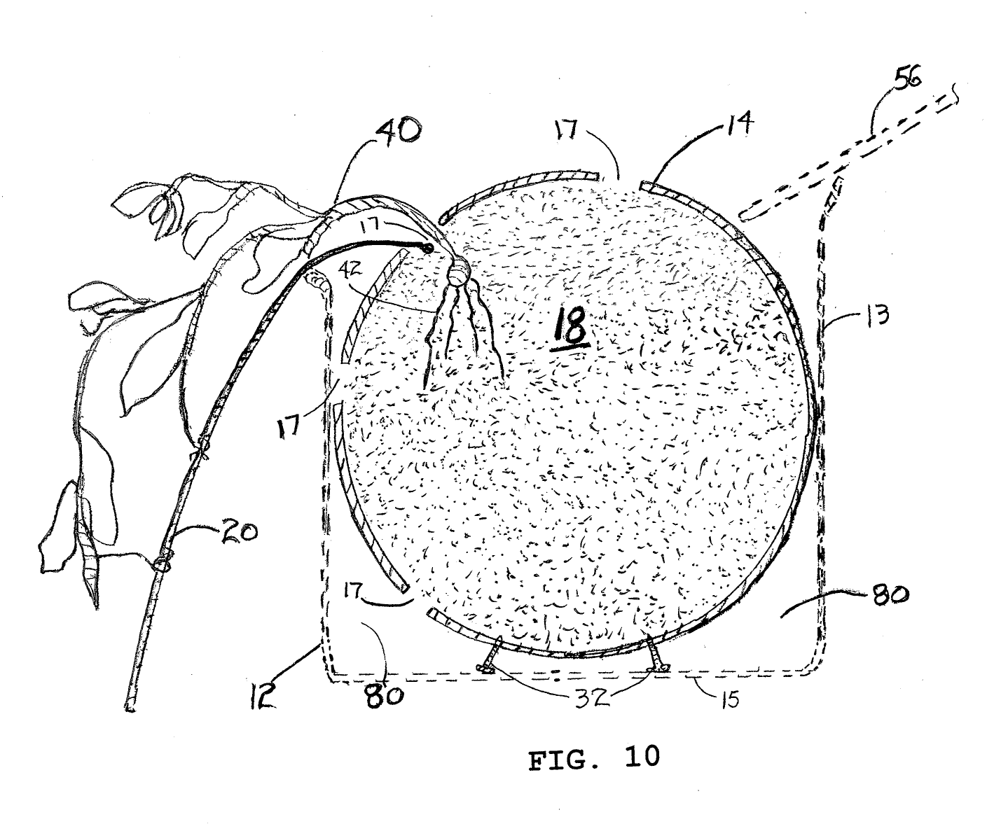

FIG. 10 is a cross sectional view of an alternative means of engaging the trellis strings 20 of the present invention with a gutter 12 to enable growing plants 40 downward along strings 20 upon which climbing plants are also growing up. The cylindrical shell 14 with at least three rows of apertures 17 rests against the bottom gutter surface 15 and fits tangentially against the front side 12 and the back side 13, still allowing rain water channels 30. At least one aperture or row of apertures is near the low point so that excess water can drain out. Another longitudinal row of apertures 17 is preferably positioned just under the edge of the shingles 16 to aid in capturing rain water runoff. Preferably, but optionally, short legs 32 or shims hold the cylinder shell 14 slightly off the bottom 15 and prevent rotation. Soil mix 18 inside the cylinder 14 holds plant roots 42 of the plant 40 growing out of the apertures 17, which are about one-half inch diameter or larger. Preferably, the soil mix 18 contains super-absorbent particles for greater and longer water retention, and optionally fertilizer is included. Strings 20 loop through at least two adjacent apertures 17 and emanate from some of the apertures 17 and extend downward providing a location to which a downward-growing plant 40 can latch on or be entwined. Some climbing plants will not actually climb downward, but will hang down and grow down.

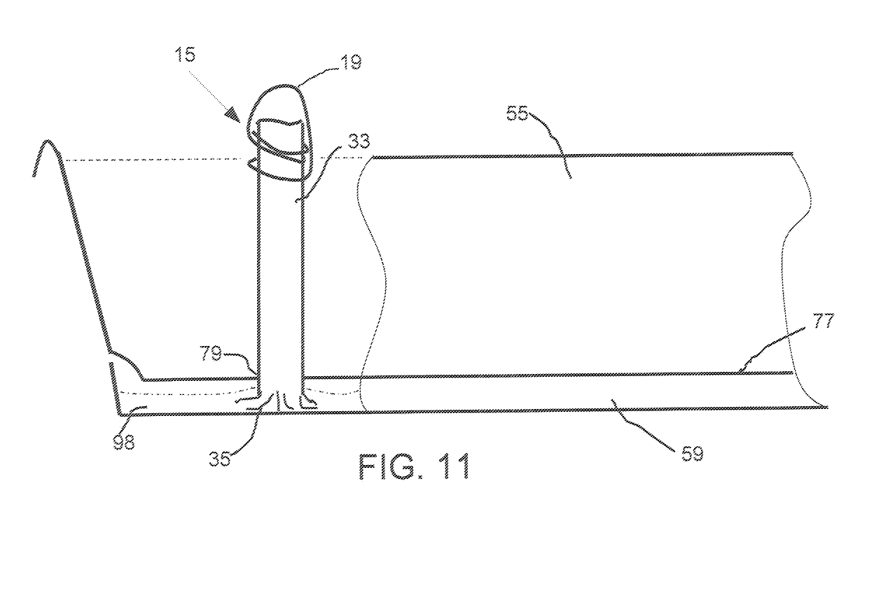

FIG. 11 is a partial cross-sectional cutaway elevation view of an alternative embodiment of a portion of the present invention. An elongated planter box 55 has a removable bottom water tray 59, which can collect and hold a pool of water 98. The loop peg member 15 in this instance is a column of water-absorbent wick material 33 disposed vertically up through an aperture 79 in the bottom 77 of the planter box 55. The wick column may be a 8 to 12 inch length of felt rope. A splayed-out end 35 retards pulling out of the aperture 79 while also spreading out to facilitate absorption of water in the pool 98. The wicking action of the column of wick material 33 makes water more available to roots of the plants planted in the planter box 55. A loop 19 for tying on the strings of the trellis is attached to the upper end of the wick column 33 by compression or other suitable methods.

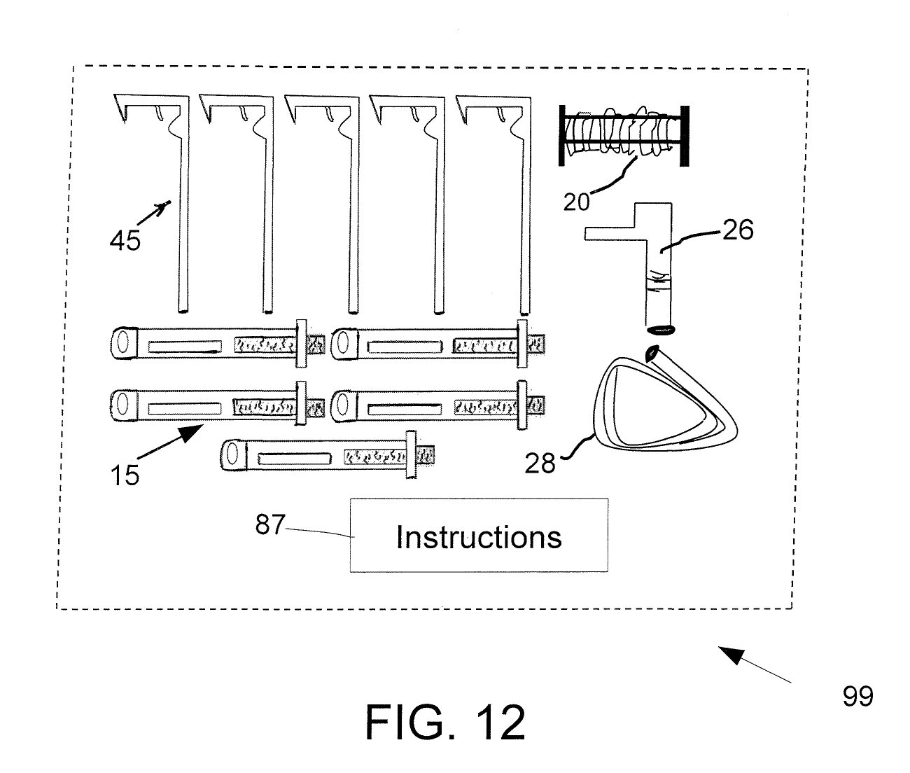

FIG. 12 provides a plan view of a kit assembly 99 of the present invention. Included are at least four hanger members 45, at least four loop pegs 15, a spool of string 20, a downspout insert trough fitting 26, a section of flexible tubing 28, and a set of instructions 87. The collection of parts would be packaged in one of many acceptable ways, such as covering the array on a cardboard backing with shrink wrap. The kit assembly 99 offers a convenient way for consumers to acquire all the elements needed to convert an elongated planter box for trellis growing.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

We claim:

1. A string trellis apparatus for attachment to elevated substantially horizontal portions of a structure at one end and an elongated planter box at the other, said trellis apparatus comprising:
a) at least two elongated hanger members of a first predetermined length each having at least one aperture disposed at a first end and a hook portion disposed at a second end and engageable with at least one of a rain gutter and a fence top;
b) at least two substantially flexible strings having proximal and distal ends; and
c) a planter-box connecting means disposed one of in and on said planter box for removably attaching said proximal ends of said strings to said planter box adjacent a soil surface in said planter box.

2. The string trellis apparatus, according to claim 1, wherein said planter-box connecting means are loop posts of a predetermined height with a loop disposed at a top end and a flange at a bottom end.

3. The string trellis apparatus, according to claim 1, wherein said planter-box connecting means are columns of wick material of a predetermined height with a loop disposed at a top end and a splayed bottom end.

4. The string trellis apparatus, according to claim 2, wherein said loop posts include tubes with window slits and internal wick material.

5. The string trellis apparatus, according to claim 1, wherein said predetermined length is between about 8 and 24 inches.

6. The string trellis apparatus, according to claim 2, wherein said predetermined height is between about 8 and 12 inches.

7. The string trellis apparatus, according to claim 1, wherein said planter box connecting means is a plurality of apertures spaced along a top edge of said planter box.

8. The string trellis apparatus, according to claim 2, wherein said loops are releasably connected to elastic bands.

9. The string trellis apparatus, according to claim 1, wherein said elongated hanger members are L-shaped with a pronged tip at a distal end of hook section of predetermined length and substantially perpendicular to an elongated member thus being engageable with both a gutter and a fence top.

10. The string trellis apparatus, according to claim 2, wherein said loop posts are engageable with apertures in two telescoping channel pieces removably disposed along a bottom of said planter box.

11. The string trellis apparatus, according to claim 9, wherein said elongated L-shaped hanger members further include a hump on said elongated member and a tongue protrusion on an underside of said hook member.

12. A string trellis kit for creating a flexible adjustable height trellis between an elongated planter box and a substantially horizontal portion of a structure, said trellis kit comprising:
a) at least four hanger members;
b) at least four loop pegs;
c) a spool of string 20;
d) a downspout insert trough fitting;
e) a section of flexible tubing; and
f) a set of instructions.
